(19) United States
(12) Patent Application Publication
(10) Pub. No.: US 2026/0140778 A1
(43) Pub. Date: May 21, 2026

(54) GENERATING ITERATION TRANSFER INFORMATION FOR CODE EXECUTION WITH A COMPUTE SLICE MICROARCHITECTURE

(71) Applicant: Ascenium, Inc., Mountain View, CA (US)

(72) Inventors: Hans Olle Viktor Fredriksson, 0187 Oslo (NO); Tore Jahn Bastiansen, 4022 Stavanger (NO); Ove Brynestad, 1383 Asker (NO); Øyvind Harboe, 4017 Stavanger (NO)

(73) Assignee: Ascenium, Inc., Mountain View, CA (US)

(21) Appl. No.: 19/446,865

(22) Filed: Jan. 12, 2026

Related U.S. Application Data
(63) Continuation-in-part of application No. 19/235,822, filed on Jun. 12, 2025.
(63) Continuation-in-part of application No. 19/197,924, filed on May 2, 2025.
(63) Continuation-in-part of application No. 19/053,495, filed on Feb. 14, 2025.
(63) Continuation-in-part of application No. 18/769,478, filed on Jul. 11, 2024.
(60) Provisional application No. 63/526,252, filed on Jul. 12, 2023.
(60) Provisional application No. 63/537,024, filed on Sep. 7, 2023.
(60) Provisional application No. 63/554,233, filed on Feb. 16, 2024.
(60) Provisional application No. 63/554,233, filed on Feb. 16, 2024.
(60) Provisional application No. 63/571,483, filed on Mar. 29, 2024.
(60) Provisional application No. 63/571,483, filed on Mar. 29, 2024.
(60) Provisional application No. 63/642,391, filed on May 3, 2024.
(60) Provisional application No. 63/642,391, filed on May 3, 2024.
(60) Provisional application No. 63/642,391, filed on May 3, 2024.
(60) Provisional application No. 63/659,401, filed on Jun. 13, 2024.
(60) Provisional application No. 63/659,401, filed on Jun. 13, 2024.
(60) Provisional application No. 63/659,401, filed on Jun. 13, 2024.
(60) Provisional application No. 63/659,401, filed on Jun. 13, 2024.
(60) Provisional application No. 63/744,394, filed on Jan. 13, 2025.
(60) Provisional application No. 63/744,394, filed on Jan. 13, 2025.
(60) Provisional application No. 63/744,394, filed on Jan. 13, 2025.

(51) Int. Cl. G06F 9/50

(52) U.S. Cl. CPC G06F 9/5027

(57) ABSTRACT

A processor core is accessed. The core is configured to execute instructions associated with an instruction set architecture (ISA). The core comprises a plurality of compute slices, a plurality of barrier register files, and a control unit. Each compute slice includes at least one arithmetic logic unit (ALU), a local register file, and is coupled to a successor compute slice and a predecessor compute slice by a barrier register file. Code associated with the ISA is evaluated, where the code includes a first loop. The evaluating includes generating iteration transfer information associated with the first loop. Each slice task within a plurality of slice tasks associated with the first loop is distributed to a compute slice. The processor core executes the plurality of slice tasks. Data forwarding between successive compute slices is based on the plurality of barrier register files and the iteration transfer information.

### RELATED APPLICATIONS

This application claims the benefit of U.S. provisional patent application “Code Translation And Forwarding With Compute Slices” Ser. No. 63/744,394, filed Jan. 13, 2025.

This application is also a continuation-in-part of U.S. patent application “Memory Dependence Prediction In A Parallel Architecture With Compute Slices” Ser. No. 19/235,822, filed Jun. 12, 2025, which claims the benefit of U.S. provisional patent applications “Memory Dependence Prediction In A Parallel Architecture With Compute Slices” Ser. No. 63/659,401, filed Jun. 13, 2024, and “Code Translation And Forwarding With Compute Slices” Ser. No. 63/744,394, filed Jan. 13, 2025.

This application is also a continuation-in-part of U.S. patent application “Global Memory Disambiguation For A Parallel Architecture With Compute Slices” Ser. No. 19/197,924, filed May 2, 2025, which claims the benefit of U.S. provisional patent applications “Global Memory Disambiguation For A Parallel Architecture With Compute Slices” Ser. No. 63/642,391, filed May 3, 2024, “Memory Dependence Prediction In A Parallel Architecture With Compute Slices” Ser. No. 63/659,401, filed Jun. 13, 2024, and “Code Translation And Forwarding With Compute Slices” Ser. No. 63/744,394, filed Jan. 13, 2025.

This application is also a continuation-in-part of U.S. patent application “Compiler Generated Hyperblocks In A Parallel Architecture With Compute Slices” Ser. No. 19/053,495, filed Feb. 14, 2025, which claims the benefit of U.S. provisional patent applications “Compiler Generated Hyperblocks In A Parallel Architecture With Compute Slices” Ser. No. 63/554,233, filed Feb. 16, 2024, “Local Memory Disambiguation For A Parallel Architecture With Compute Slices” Ser. No. 63/571,483, filed Mar. 29, 2024, “Global Memory Disambiguation For a Parallel Architecture With Compute Slices” Ser. No. 63/642,391, filed May 3, 2024, “Memory Dependence Prediction In A Parallel Architecture With Compute Slices” Ser. No. 63/659,401, filed Jun. 13, 2024, and “Code Translation And Forwarding With Compute Slices” Ser. No. 63/744,394, filed Jan. 13, 2025.

This application is also a continuation-in-part of U.S. patent application “Parallel Architecture With Compiler-Scheduled Compute Slices” Ser. No. 18/769,478, filed Jul. 11, 2024, which claims the benefit of U.S. provisional patent applications “Parallel Architecture With Compiler-Scheduled Compute Slices” Ser. No. 63/526,252, filed Jul. 12, 2023, “Semantic Ordering For Parallel Architecture With Compute Slices” Ser. No. 63/537,024, filed Sep. 7, 2023, “Compiler Generated Hyperblocks In A Parallel Architecture With Compute Slices” Ser. No. 63/554,233, filed Feb. 16, 2024, “Local Memory Disambiguation For A Parallel Architecture With Compute Slices” Ser. No. 63/571,483, filed Mar. 29, 2024, “Global Memory Disambiguation For A Parallel Architecture With Compute Slices” Ser. No. 63/642,391, filed May 3, 2024, and “Memory Dependence Prediction In A Parallel Architecture With Compute Slices” Ser. No. 63/659,401, filed Jun. 13, 2024.

Each of the foregoing applications is hereby incorporated by reference in its entirety.

### FIELD OF ART

This application relates generally to task processing and more particularly to generating iteration transfer information for code execution with a compute slice microarchitecture.

### BACKGROUND

The old adage, “divide and conquer,” has often been practically and successfully applied in a wide variety of contexts. Whether applied to an organization or a design, partitioning a large system or design into smaller pieces, and assigning those pieces to teams or individuals best suited to handle those pieces, has been demonstrated to be the most effective strategy when addressing complex systems and designs. Management experts point out that the dividing and sharing of tasks is an essential component of effective teamwork. This approach further enhances project management since progress interruptions and delayed parts can be quickly identified and addressed. And, by assigning tasks to teams and individuals based on strengths, expertise, and most critically, availability, enables a balanced workload across teams and individuals, and maximized implementation efficiency. Thus, whether dividing a large research project, or partitioning a design project into judicious sectioning of large tasks, the assignment of sections to appropriate groups or individuals is often the best approach to achieving favorable outcomes.

The concepts of divide and conquer also apply to processing jobs. A typical organization such as a government, enterprise, hospital, or university, among others, executes a wide variety of processing jobs daily, weekly, monthly, and annually. The processing jobs include billing and payroll, running statements of accounts, and handling taxes. Other processing jobs include determining election results, controlling experiments, analyzing research data, and generating academic grades. The computational resources that are consumed by job processing are housed in data centers that operate 24×7×365. These processing jobs must be executed accurately and cost effectively. The data that is processed is often unstructured and held in huge datasets. The volume of data to be processed cannot be handled by traditional computational resources. Instead, advanced resource configurations are required for tasks from detecting a specific data element to processing an entire dataset. Effective dataset processing supports enterprise and organizational objectives by enabling customer relationship management; potential customer identification; and refining manufacturing, distribution, data analysis, and other systems for efficiency and competitive advantage.

Data collected and processed by any organization is often its most valuable and highly protected asset. Sets of collected data, or “datasets,” are typically vast and unstructured, thus presenting significant processing challenges. The processing aims to achieve core organizational purposes and objectives. Large and complex computational resources are required to process the enterprise and organizational datasets. The computational resources include communications and networking equipment, data storage units, HVAC equipment, processors, power conditioning units, backup power units, and other essential equipment. These resources consume prodigious amounts of energy and produce copious heat, necessitating energy source management. Computational resources are located in purpose-built, high-security installations. Some organizations do not require vast computational equipment installations, yet all must provide resources to meet their data processing needs as quickly and cost effectively as possible.

### SUMMARY

As new applications are created, the demand for processors with higher and higher performance continues to rise. Additional performance to meet the needs of applications such as cryptocurrency mining, molecular simulations, artificial intelligence, weather forecasting, and so on can be obtained through a number of methods. One such method is to increase processing speed. However, processor speeds can eventually be limited by long wire paths that do not scale well as lithography advances. Higher frequency can also lead to more power consumption, making chips difficult to cool. Another method of increasing performance is to increase parallelism. Methods of increasing parallelism include out-of-order (OoO) execution, pipelining, branch prediction/speculative execution, multi-threading, adding additional cores, and so on. Disclosed is another method of generating additional parallelism, and therefore additional performance, by enabling a plurality of compute slices within a processor core.

Techniques for parallel execution of code and loops with compute slices are disclosed. A processor core is accessed. The processor core is configured to execute instructions associated with an instruction set architecture (ISA) such as a RISC-V™ ISA. The processor core includes a plurality of compute slices, a plurality of barrier register files, and a control unit. Each compute slice includes at least one arithmetic logic unit (ALU) and a local register file. Each compute slice is coupled to a successor compute slice and a predecessor compute slice by a barrier register file in the plurality of barrier register files. Code associated with the ISA is evaluated. Evaluating includes generating iteration transfer information associated with the first loop. Iteration transfer information identifies which registers are modified by a compute slice and which registers are not. Unmodified registers can be forwarded through to enable a successor slice to begin processing of the unmodified data. Each slice task associated with the first loop is distributed to a compute slice within the plurality of compute slices. The processor core executes the plurality of slice tasks. Data forwarding between successive compute slices within the plurality of compute slices is based on the plurality of barrier register files and the iteration transfer information.

A processor-implemented method for task processing is disclosed comprising: accessing a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files; evaluating code associated with the ISA, wherein the code includes a first loop, wherein the evaluating includes generating iteration transfer information associated with the first loop; distributing each slice task within a plurality of slice tasks associated with the first loop to a compute slice within the plurality of compute slices; and executing, by the processor core, the plurality of slice tasks, wherein data forwarding between successive compute slices within the plurality of compute slices is based on the plurality of barrier register files and the iteration transfer information. In some embodiments, the plurality of compute slices includes a first compute slice executing a first slice task within the plurality of slice tasks that were distributed. In one or more embodiments, the plurality of compute slices includes a second compute slice executing a second slice task within the plurality of slice tasks that were distributed, wherein the first compute slice is coupled to the second compute slice by a first barrier register file within the plurality of barrier register files. In some embodiments, the generating includes forming, for the first slice task, a first register write mask (RWM), wherein the first RWM identifies one or more registers, within the first slice task, that are modified by the first slice task. In some embodiments, the executing includes writing, by the first compute slice, data associated with the one or more instructions that were identified by the first IWM, to both the local register file within the first compute slice and the first barrier register file. In one or more embodiments, the generating includes forming, for the first slice task, a first register write mask (RWM), wherein the first RWM identifies one or more registers, within the first slice task, that are modified by the first slice task. In some embodiments, the executing includes forwarding, by the first compute slice, data associated with one or more registers that were not identified by the first RWM, from a predecessor barrier register file to the first barrier register file.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for generating iteration transfer information for code execution with a compute slice microarchitecture.

FIG. 2 is a flow diagram for generating masks.

FIG. 3 is a block diagram for compute slice control.

FIG. 4 illustrates a block diagram for a ring configuration of compute slices.

FIG. 5 is an example of barrier registers.

FIG. 6 is an example of slice task execution with write masks.

FIG. 7 is a system diagram for generating iteration transfer information for code execution with a compute slice microarchitecture.

### DETAILED DESCRIPTION

Data mining, image processing, genomic sequencing, autonomous vehicle technology, and virtual reality technology are a few examples of technologies that have fueled the increased demand for compute power. As a result, modern day organizations have experienced an ever-accelerating need for faster and more capable compute resources. Computer architectures and implementations have attempted to meet this need by increasing parallelism, increasing clock speeds, and proposing various architectures and extensions to provide task-specific processing. These approaches, while effective to a degree, must continually be reevaluated and improved to meet the needs of emerging and future applications. Further, additional technologies will be needed to provide additional compute power to serve current and next generation applications.

To address this ongoing need for performance, techniques for generating iteration transfer information for code execution with a compute slice architecture are disclosed. A processor core is accessed, where the processor core is configured to execute instructions associated with an instruction set architecture (ISA). The ISA can include a RISC-V™ ISA. The processor core comprises a plurality of compute slices, a plurality of barrier register files, and a control unit. The processor core can access a memory system. Each compute slice within the plurality of compute slices includes at least one arithmetic logic unit (ALU), a local register file, and is coupled to a successor compute slice and a predecessor compute slice by a barrier register file in the plurality of barrier register files. Code associated with the ISA is evaluated, where the code includes a first loop. The evaluating includes generating iteration transfer information associated with the first loop. The transfer information can be used to enable data forwarding. Each slice task within a plurality of slice tasks associated with the first loop is distributed to a compute slice within the plurality of compute slices. The distributing can be based on a branch prediction logic within the control unit. The processor core executes the plurality of slice tasks. Data forwarding between successive compute slices within the plurality of compute slices is based on the plurality of barrier register files and the iteration transfer information.

A processor core comprising a plurality of compute slices, a control unit, and a memory system is accessed. Each compute slice in the processor core includes an arithmetic logic unit (ALU) and a local register file. The local register file can be used to store intermediate results within the compute slice, to forward results to another compute slice, and so on. Each compute slice is coupled to a successive compute slice and a predecessor compute slice. Code is evaluated by the processor core. The code includes a loop. While evaluating the code, loop transfer information is generated that is associated with the loop. The loop transfer information can include an instruction write mask which can identify one or more instructions within the loop that produce a final write to an architected register file. The loop transfer information can include a register write mask which can indicate one or more architectural registers that are modified within each loop iteration. The code is executed by the processor core. The executing includes distributing one or more iterations of the loop to successive compute slices. The executing is based on the iteration transfer information which guides data transfer between compute slices. The processing of immense, varied, and often unstructured datasets supports a wide variety of organizational missions and purposes. The organizations include commercial, educational, governmental, medical, research, or retail ones, to name only a few. The datasets can also be analyzed for law enforcement and forensic purposes. Computational resources are specified, configured, and deployed by the organizations to meet critical organizational needs. The organizations range in size from sole proprietor operations to large, international organizations. The computational resources include processors, data storage units, networking and communications equipment, telephony, power conditioning units, HVAC equipment, and backup power units, among other essential equipment. Further, energy resource management is critical since the computational resources consume prodigious amounts of energy and produce copious heat. The computational resources are housed in special-purpose, high reliability and frequently high-security installations. The magnitude of the computational resources can vary by organization, but all organizations endeavor to provide resources to meet their data processing needs as quickly and cost effectively as possible.

Programs that are executed by the compute slices within the processing unit can be associated with a wide range of applications. The applications can be based on data manipulation, such as image, video, or audio processing applications; AI and machine learning applications; business applications; data acquisition and analysis; and so on. The tasks that are executed can perform a variety of operations including arithmetic operations, shift operations, logical operations including Boolean operations, vector or matrix operations, tensor operations, and the like. The subtasks can be executed based on branch prediction, operation precedence, priority, coding order, amount of parallelization, data flow, data availability, compute element availability, communication channel availability, and so on. Slice tasks that comprise a compiled program are generated by a compiler. The compiler can include a general-purpose compiler, a hardware description-based compiler, a compiler written or “tuned” for the specific number of compute slices in the processor core, a constraint-based compiler, a satisfiability-based compiler (SAT solver), and so on.

Control is provided to the hardware by the control unit which allocates slice tasks to compute slices. The control unit can include branch prediction hardware. The allocating can be based on the branch prediction hardware. A branch instruction can require evaluating an expression. The expression can include a logical expression, a mathematical expression, and so on. The control unit can allocate code (or a slice task) associated with a predicted branch outcome on a successor compute slice speculatively before the operands of the logical expression are known. Once issued, the slice tasks are executed independently from the control unit and other compute slices until they are either halted by the control unit, indicate an exception, finish executing, etc. When the operands for the logical expression are known, the control unit can check that the code running on the successor compute slice task is a next sequential slice task in the compiled program. The checking can be based on execution of the first compute slice. If the second slice task is the next sequential slice task, then execution can proceed. If the successor slice task is not the next sequential slice task, then results from the successor compute slice are discarded. All further downstream compute slices can also be discarded.

The compute slices within the processor core can be implemented with central processing units (CPUs), graphics processing units (GPUs), application specific integrated circuits (ASICs), field programmable gate arrays (FPGAs), processor cores, or other processing components or combinations of processing components. The compute slices can include heterogeneous processors, homogeneous processors, processor cores within an integrated circuit or chip, etc. The compute slices can comprise one or more RISC-V™ processors. The compute slices can be coupled to local storage, which can include load-store units, local memory elements, register files, cache storage, etc. The cache, which can include a hierarchical cache such as an L1, L2, and L3 cache, can be used for storing data such as intermediate results, compute element operations, and the like. Any level of cache (e.g., L1, L2, L3, etc.) can be shared by two or more compute slices. The various elements of the processing unit can further include elements within an integrated circuit, elements within an application specific integrated circuit (ASIC), elements programmed within a programmable device such as a field programmable gate array (FPGA), and so on. The processing unit can include homogeneous or heterogeneous processors. The coupling of each compute slice to a successor compute slice and a predecessor compute slice by a barrier register set enables data communication between compute slices. Thus, the control unit can control data flow between the compute slices and can further control data commitment to the barrier register set and to memory outside of the processing unit.

Code associated with the instruction set architecture is evaluated, where the code includes a first loop. The evaluating includes generating iteration transfer information associated with the first loop. The iteration transfer information seeks to accomplish two main goals. The first goal is to determine which instructions within the loop perform a final write. A final write can include writing changes that can be made within the loop to a register such as an architectural register. Instructions that perform a final write necessitate writing data to both a local register or register file and to an output register. The data is read from an input such as a barrier register coupled between the compute slice to which the instruction is assigned and a predecessor compute slice. The output register can be coupled to an input stage of a barrier register coupled between the compute slice and a successor compute slice. The first goal generates a first instruction mask. The second goal is to identify one or more registers within the first slice task, which are modified by the first slice task. The registers are modified by one or more instructions within a slice task that is executed by the compute slice. Thus, reading data within the registers that are modified must be delayed until the data in the registers is finalized. The second goal is to form a register write mask (RWM), where the RWM identifies one or more registers, within the first slice task, which are modified by the first slice task. However, registers that are not included in the RWM are not modified within the slice task. Thus, the unmodified registers can be forwarded from a predecessor barrier register file to a successor barrier register file. That is, the data can be “written through” the compute slice and made available to a successor compute slice that requires the data.

The iteration transfer information, the instruction write mask, and the register write mask can be stored within metadata within a binary associated with the code. The metadata can indicate how a register is used by the binary and how data within the register is to be handled. The metadata can indicate that a register is used as an input, is used locally within a loop, and so on. The metadata can indicate that data is to be written to a local register within the compute slice, to an output register, or to both a local register and an output register. The metadata enables data that is unchanged by a slice task to be forwarded through the compute slice on which the slice task is executing to an output barrier register and onward to a successor compute slice that requires the data. The data forwarding can enable the subsequent compute slice to begin execution while the compute slice is still executing.

A first slice task is allocated by the control unit to a first compute slice in the plurality of compute slices. A second slice task is allotted, by the control unit, to a second compute slice in the plurality of compute slices. The second compute slice is coupled to the first compute slice by a first barrier register set in the plurality of barrier register sets. The first barrier register set enables unidirectional communication between the first compute slice and the second compute slice. Thus, the first compute slice can write to the first barrier register set and the second compute slice can read from the first barrier register set. Pointers can be used and initialized to determine which compute slices are issued to the first slice task and the second slice task. Pointers that point to compute slices can be initialized. A head pointer can point to the first compute slice, and a tail pointer can point to the second compute slice. The head pointer and the tail pointer can be updated based on slice task execution status, conditional operation outcome determination, and so on. A compiled program is executed, where the executing begins at the first compute slice. Executing multiple slice tasks on two or more compute slices enables parallelized operations. The parallelized operations enable parallel execution of the first slice task and the second slice task. The second slice task is the predicted outcome of the conditional operation. The parallelized operations can include primitive operations that can be executed in parallel. A primitive operation can include an arithmetic operation, a logical operation, a data handling operation, and so on.

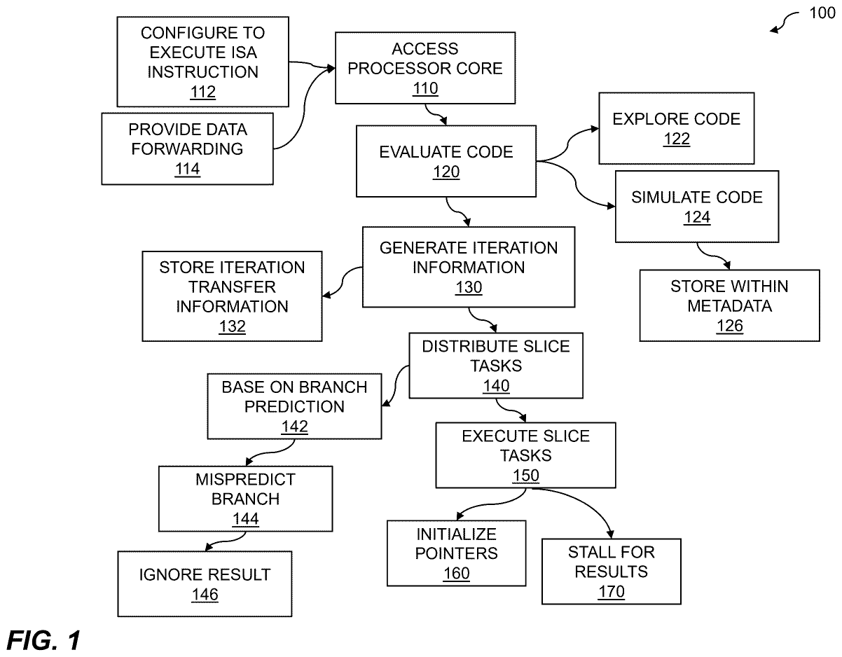

FIG. 1 is a flow diagram for generating iteration transfer information for code execution with a compute slice microarchitecture. Compute slices within a processor core can be issued blocks of code for execution, where the blocks of code are called slice tasks. The slice tasks can be associated with a compiled program. The compiled program, when executed, can perform a variety of operations associated with data processing. The processor core can include elements such as compute slices, barrier register files, and a control unit. The processor core further interface with other elements such as ALUs, GPUs, multicycle elements (MCEs), and so on. The operations can accomplish a variety of processing objectives such as application processing, data manipulation, data analysis, modeling and simulation, and so on. The operations can accomplish artificial intelligence (AI) applications such as machine learning. The operations can manipulate a variety of data types including integer, real, floating-point, and character data types; vectors, matrices, and arrays; tensors; etc.

The flow 100 includes accessing 110 a processor core. Embodiments include accessing a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files.

The processor core is configured to execute instructions associated with an ISA 112. Each compute slice within the processor core can execute code associated with an ISA such as x86, ARM™, a proprietary ISA, instructions associated with an ISA extension, and so on. In some embodiments, the ISA comprises a RISC-V™ ISA. The execution of ISA instructions can be combined with execution of custom instructions. The barrier register set provides for communication of data between successive compute slices. The compute slices can be based on or can include a variety of types of processors. The compute slices can include central processing units (CPUs), graphics processing units (GPUs), processors or processor cores within application specific integrated circuits (ASICs), processor cores programmed within field programmable gate arrays (FPGAs), and so on. In a usage example, compute slices within the processing unit can have identical functionality. In another usage example, the compute slices within the processing unit can have different functionality.

The barrier register sets to which the compute slices can be coupled can enable data transfer between compute slices. The data transfer enabled by the barrier register sets can be unidirectional. The coupling compute slices to successor compute slices enables sharing of data between code (which can be called slice tasks) running on one or more compute slices. Data can be forwarded 114 between successive compute slices. Discussed below, data forwarding enables registers that will be unchanged by a compute slice to be forwarded from a compute slice to a barrier register coupled between the compute slice and a successor compute slice. The data forwarding enables a successor compute slice to begin processing before the first compute slice completes executing its slice task. In some embodiments, the plurality of compute slices and the plurality of barrier register files are coupled in a ring configuration. Thus, the last compute slice can forward results to the first compute slice.

A compiler can be used to compile code for the processor core. The compiler can include C, C++, or another language. The compiler can include a compiler written especially for the processor core. The processor core can run code written in an interpreted language such as Python. The compiler can be used to generate one or more blocks of code or slice tasks that can be mapped, by the control unit, to the compute slices. The slice tasks are assigned to one or more compute slices. Depending on the type and size of a task that is compiled for execution on the processing unit, one or more of the compute slices can execute slice tasks, while other compute slices are unneeded by the particular task. A compute slice that is unneeded (e.g., because it has completed an assigned slice task, because there is no current slice task to be assigned, etc.) can be marked as idle. An idled compute slice requires no data and no further information. The idling of a compute slice can be accomplished using a control bit. The idling of compute slices within the processing unit can decrease power consumption of the processing unit. The slice tasks that are generated by the compiler can include a conditionality such as a branch. Each slice task can include one or more branch instructions. The branch can include a conditional branch, an unconditional branch, etc.

The flow 100 includes evaluating code 120 associated with the ISA, wherein the code includes a first loop, wherein the evaluating includes generating iteration transfer information associated with the first loop. A control unit within the processor core can distribute slice tasks to a plurality of compute slices within the processor core. Thus, a first compute slice can be assigned a first slice task, a second compute slice can be assigned a second slice task, and so on. The slice tasks can be associated with a code loop, such that the code loop can be parallelized by multiple compute slices, each running an iteration of the code loop (e.g., a slice task). The code can be evaluated such that the control unit can distribute the slice tasks and allow for variable passing between compute slices. Code evaluation can be accomplished using a variety of techniques. In some embodiments, the evaluating includes exploring the code 122, by the processor core, in an information gathering mode, wherein the generating the iteration transfer information is based on the exploring. The evaluating can include determining data dependencies between slice tasks. The evaluating can be performed at various times. In one or more embodiments, the exploring occurs at runtime. While the exploring might also occur at compile time, conditional instructions such as those that are based evaluations of data can only be predicted prior to runtime. The iteration transfer information that is generated can be stored in various locations. In some embodiments, the generating includes storing the iteration transfer information within the control unit. Thus, the control unit can send the iteration transfer information, along with the slice task, to each compute slice for execution and for controlling variable passing between loop iterations running on the various compute slices.

The evaluating can be accomplished using other techniques in addition to exploring. In some embodiments, the evaluating includes simulating the code 124, by a compiler, wherein the generating the iteration transfer information is based on the simulating. The compiler can include a C, C++, or another language compiler. The compiler can include a compiler written especially for the processor core. In one or more embodiments, the simulating occurs at compile time. The iteration transfer information that is generated by the simulating can be stored in various locations. Some embodiments include storing the iteration transfer information within metadata 126 within a binary associated with the code. The metadata can be used to indicate to the compute slice that data can be obtained from an input, written locally to the compute slice, written to an output, written locally to both the compute slice and an output, etc.

The evaluating includes generating iteration transfer information 130 associated with the first loop. In some embodiments, the generating includes creating, for the first slice task, a first instruction write mask (IWM), wherein the first IWM identifies one or more instructions, within the first slice task, that produce a final write to an architectural register. An architectural register can include a register within the processor core. The architectural register can be used to hold data, addresses, status information, etc. The architectural registers can include various types of registers such as integer registers, command and status registers, etc. The architectural registers can be defined by the instruction set architecture (ISA). In a usage example, architectural registers are associated with a RISC-V™ ISA. A final write can include a write from a compute slice to a barrier register coupled between two adjacent compute slices. The final write can depend on a branch instruction. The writing can occur when executing the instructions identified by the IWM. In some embodiments, the executing includes writing, by the first compute slice, data associated with the one or more instructions that were identified by the first IWM to both the local register file within the first compute slice and the first barrier register file. The writing can be performed synchronously or asynchronously. The writing can enable passing of data between compute slices running iterations of a code loop.

In further embodiments, the generating includes forming, for the first slice task, a first register write mask (RWM), wherein the first RWM identifies one or more registers, within the first slice task, that are modified by the first slice task. The registers identified and included in the RWM can include registers that are modified by the slice task executed on a compute slice, while registers not within the RWM can remain unmodified. As a result, unmodified registers (e.g., those registers not within the RWM) can be forwarded through the compute slice to a barrier register file and sent directly to a successor compute slice that requires the data within the unmodified registers. In some embodiments, the executing includes forwarding, by the first compute slice, data associated with one or more registers that were not identified by the first RWM, from a predecessor barrier register file to the first barrier register file. The forwarding enables “pass through” of the unmodified data, thereby enabling the successor compute slice to the compute slice to begin execution prior to completion of the slice task assigned to the compute slice.

In some embodiments, the generating includes storing the iteration transfer information 132 within the control unit. The iteration transfer information can be stored within a register file within the control unit. The iteration transfer information can be accessible by the compute slices, provided to the compute slices, and so on. Discussed previously, the iteration transfer information can be stored within metadata within the code binary. The metadata can direct the compute slice to write to a local register, to write to an output register, to write to both a local register and an output register, etc.

The flow 100 includes distributing 140 each slice task within a plurality of slice tasks associated with the first loop to a compute slice within the plurality of compute slices. The code to be executed by the processor includes a first loop. The loop can be “unrolled” or partitioned into tasks (e.g., “loop tasks” or “slice tasks”). The partitioning can be accomplished by a control unit associated with the processor core. The control unit can distribute each slice task to a compute slice within the processor core. In some embodiments, each slice task within the plurality of slice tasks comprises one or more instructions that were distributed to a compute slice within the plurality of compute slices. Depending on the number of slice tasks to distribute, not all compute slices may receive a slice task. Compute slices that do not receive a slice task can be idled, can receive a slice task from a second loop, and so on. The distribution of slice tasks can be based on various task distribution techniques including “push” techniques such as round robin, weighted round robin, least task first, max-availability, and so on. The distribution of slice tasks can be based on a “pull” technique, where slice tasks are pulled from a queue such as a task priority queue. The distribution can be based on dependencies between slice tasks. In a usage example, a portion of the distributed slice tasks can execute in parallel, other slice tasks can be executed sequentially, etc. Any number of slice tasks can be sent to the compute slices by the control unit. The distributing can be based on the iteration information (e.g., one or more IWMs, one or more RWMs, etc.). As described above, the RWM can indicate one or more architectural registers that are modified within each slice task, loop iteration, and so on. The register write mask can then be used to send data efficiently between compute slices. Local registers not written within a loop iteration running on a compute slice can be forwarded to the subsequent slice. The forwarding can occur prior to slice task completion by the compute slice without resulting in data loss since it is based on the iteration transfer information.

In some embodiments, the distributing is based on branch prediction logic 142 within the control unit. The use of branch prediction can enhance the processing speed of the processor core by enabling execution of code, a slice task, and so on to proceed before a branch decision is made. In a usage example, executing begins at the first compute slice. While one slice task is executed, other slice tasks may, in some cases, be executed in parallel. As previously discussed, the control unit can include branch prediction logic. The branch prediction logic can include static or dynamic branch prediction. The branch prediction can include hardware elements such as one or more saturating counters, one or more branch history tables, one or more branch target buffers, and so on. Branch prediction can be based on a hybrid branch prediction scheme such as a tagged geometric predictor (TAGE) or a TAGE variant such as a tournament predictor. The branch prediction can further make use of software hint instructions.

The branch prediction logic can make a prediction regarding which branch path associated with a conditional operation will likely be taken prior to the evaluation of the branch instruction. Based on the branch prediction, one or more instructions associated with a predicted branch path can be sent to a compute slice (e.g., a slice task), which can comprise an iteration of a loop within software. Multiple loops can execute in parallel, in anticipation of having predicted the branch correctly. When the branch is predicted correctly, the resulting execution can result in performance gains due to parallelism. However, the branch may not be predicted correctly by the control unit. In some embodiments, a branch instruction in the first compute slice was mispredicted 144. When a branch is mispredicted, the control unit “unrolls” results from the point of the misprediction. For example, the control unit may have mispredicted a branch such that the results from a first compute slice are accurate, but a second compute slice are incorrect. Some embodiments include ignoring 146 a result from the second compute slice, by the branch prediction logic. If the branch was predicted correctly, the compute slice can continue with execution of the code slice. Thus, the first compute slice can include branch prediction hardware. The branch prediction can be made based on examining the compiled code, runtime analysis of the code, and so on.

The flow 100 includes executing 150, by the processor core, the plurality of slice tasks, wherein data forwarding between successive compute slices within the plurality of compute slices is based on the plurality of barrier register files and the iteration transfer information. Discussed previously, a program executing on the processor core can include a plurality of slice tasks, where the slice tasks can be determined by the control unit. In some embodiments, the plurality of compute slices includes a first compute slice executing a first slice task within the plurality of slice tasks that were distributed. The first slice task can be associated with a loop such as a first loop. In some embodiments, the plurality of compute slices includes a second compute slice executing a second slice task within the plurality of slice tasks that were distributed, wherein the first compute slice is coupled to the second compute slice by a first barrier register file within the plurality of barrier register files. The first compute slice can write or store data to the first barrier register file, and the second compute slice can read or load data from the first barrier register file. In some embodiments, the first barrier register file comprises an output register file associated with the first compute slice. The output register can be written to as computations are completed by the slice task executing on the first compute slice or can be written upon completion of the slice task. In one or more embodiments, the first barrier register file comprises an input register file for the second compute slice. The second compute slice can load valid data from the first barrier register and begin executing the slice task assigned to it.

In some embodiments, the executing includes initializing 160 one or more pointers, wherein a head pointer within the one or more pointers points to a first compute slice, and wherein a tail pointer within the one or more pointers points a last compute slice. The pointers can each point to a compute slice within the plurality of compute slices. A head pointer points to the first compute slice, and a tail pointer points to a last compute slice to which the control unit has allocated a slice task (which can be the second compute slice or another compute slice). The pointers can both point to the same compute slice when only one slice task is loaded into one compute slice, when execution of all slice tasks has completed, when no compute slice blocks are loaded with slice tasks, and so on. The pointers can be updated. The head pointer can be updated when the compute slice to which it was pointing completes execution of its slice task. In a usage example, the head pointer and the tail pointer point to the same compute slice. A first slice task can be distributed to the compute slice pointed to by the head pointer. A second slice task can be allocated to the next available compute slice that can be coupled to the first compute slice by a first barrier register set. Some embodiments include stalling 170, by the second compute slice, until one or more results from the first slice task, which are required inputs for the second slice task, are written to the first barrier register file. The stalling, while undesirable from a processing throughput point of view, enables predecessor slice tasks to complete, thereby ensuring that valid data is received by the second compute slice.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

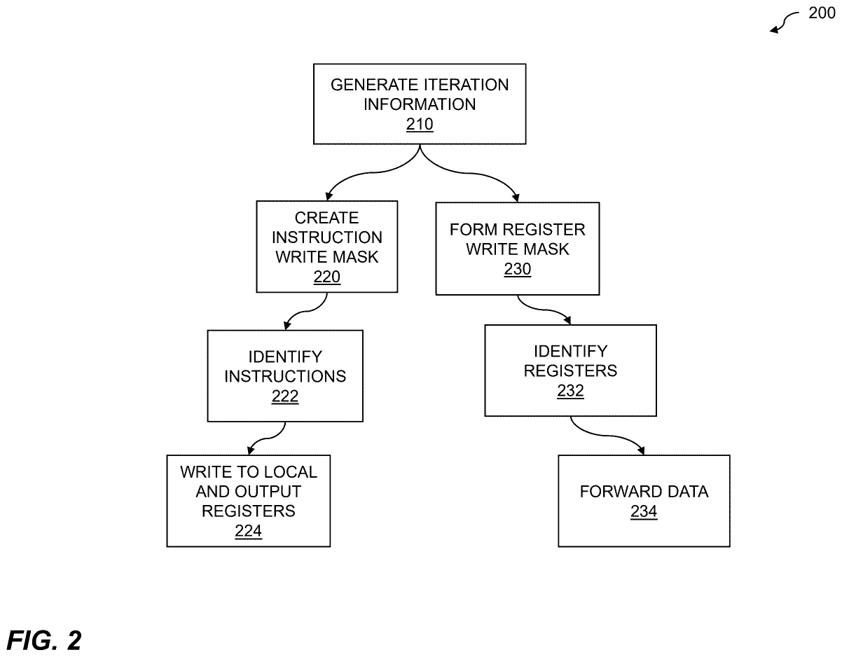

FIG. 2 is a flow diagram for generating masks. Recall that data can be forwarded from a compute slice to a successor compute slice, such as from a first compute slice to a second compute slice. The forwarding can be based on masks such as an instruction write mask (IWM) and a register write mask (RWM). The masks can be used to enhance execution of a compute task on a compute slice to write data to a local register file within the first compute slice and to a first barrier register file, or to forward by the first compute slice data from a predecessor barrier register file to a first barrier register file. Generating masks enables generating iteration transfer information for code execution with a compute slice microarchitecture.

A processor core configured to execute instructions associated with an instruction set architecture (ISA) is accessed, wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files. Code associated with the ISA is evaluated, wherein the code includes a first loop, wherein the evaluating includes generating iteration transfer information associated with the first loop. Each slice task within a plurality of slice tasks associated with the first loop is distributed to a compute slice within the plurality of compute slices. The processor core executes the plurality of slice tasks, wherein data forwarding between successive compute slices within the plurality of compute slices is based on the plurality of barrier register files and the iteration transfer information.

Two compute slices can be coupled to a barrier register set. The barrier register set can capture data generated by a compute slice, can hold data for processing by a compute slice, and so on. The barrier registers can enable data flow between an upstream (e.g., predecessor) compute slice and a downstream (e.g., successor) compute slice. The plurality of compute slices and the plurality of barrier register sets can be coupled in a ring configuration thereby enabling an “endless loop” of compute slices and barrier register sets. The ring configurations can enable functionalities such as machine learning functionality. The machine learning can be based on supervised, unsupervised, and semi-supervised learning; deep learning (DL); and the like. In a usage example, the machine learning functionality can include a neural network implementation. The compute slices can be coupled to other elements within the processor core. In a usage example, the coupling of the compute slices can enable one or more topologies. The other elements to which the compute slices can be coupled can include storage elements such as one or more levels of cache storage, multiplier units, matrix processing units, address generator units for generating load (LD) and store (ST) addresses, queues, and so on. The compute slices can each be coupled to a load-store unit. A compiler can compile code for execution on the processor. The compiler can include C, C++, or another language compiler. The processor core can execute code written in an interpreted language such as Python. The compiler can include a compiler written especially for the processor core with which the compute slices are associated. The coupling of each compute slice to other elements within the processor core enables sharing of elements such as cache elements, multicycle elements (multiplication, logarithm, square root, etc.), ALU elements, or a control unit; communications within the processing unit; and the like.

Recall that code associated with an instruction set architecture (ISA) is evaluated. The flow 200 includes generating iteration transfer information 210 associated with the first loop. When the code is executed, the loop can be iterated a plurality of times. The slice tasks that are assigned to the compute slices receive input data, typically from a predecessor compute slice, and produce output data provided to a successor compute slice. A portion of the input data to a compute slice can be modified by the compute slice while other data is forwarded from input to output unmodified. Also, a successor compute slice may use the same input data as the compute slice, may have no data dependencies on the compute slice, and so on. To support the forwarding of data elements and other data handling operations, write masks, which control writing of data to local registers within a compute slice, writing data to barrier registers, etc., can be created.

In some embodiments, the generating includes creating 220, for the first slice task, a first instruction write mask (IWM), wherein the first IWM identifies 222 one or more instructions, within the first slice task, that produce a final write to an architectural register. An architectural register can include a register within the processor core that can be used to hold data, addresses, status information, etc. The architectural registers can include integer registers, command and status registers, and so on. The architectural registers can be defined by the instruction set architecture (ISA). In a usage example, architectural registers are associated with a RISC-V™ ISA. A final write can include a write from a compute slice to a barrier register coupled between two adjacent compute slices. A final write can be based on computations performed within a slice task executed on a compute slice. The writing can occur when executing the instructions identified by the IWM. In some embodiments, the executing includes writing 224, by the first compute slice, data associated with the one or more instructions that were identified by the first IWM, to both the local register file within the first compute slice and the first barrier register file. The writing can be performed synchronously or asynchronously. Writing to the first barrier register file enables data forwarding between successive compute slices.

In further embodiments, the generating includes forming 230, for the first slice task, a first register write mask (RWM), wherein the first RWM identifies 232 one or more registers, within the first slice task, that are modified by the first slice task. The registers identified and included in the RWM can include registers that are modified by the slice task executing on a compute slice, while registers not within the RWM can remain unmodified. As a result, the unmodified registers can be forwarded through the compute slice to a successor compute slice that requires the data within the unmodified registers. In some embodiments, the executing includes forwarding 234, by the first compute slice, data associated with one or more registers that were not identified by the first RWM, from a predecessor barrier register file to the first barrier register file. The forwarding enables “pass through” of the unmodified data, thereby enabling the successor compute slice to the compute slice to begin execution prior to completion of the slice task assigned to the compute slice.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

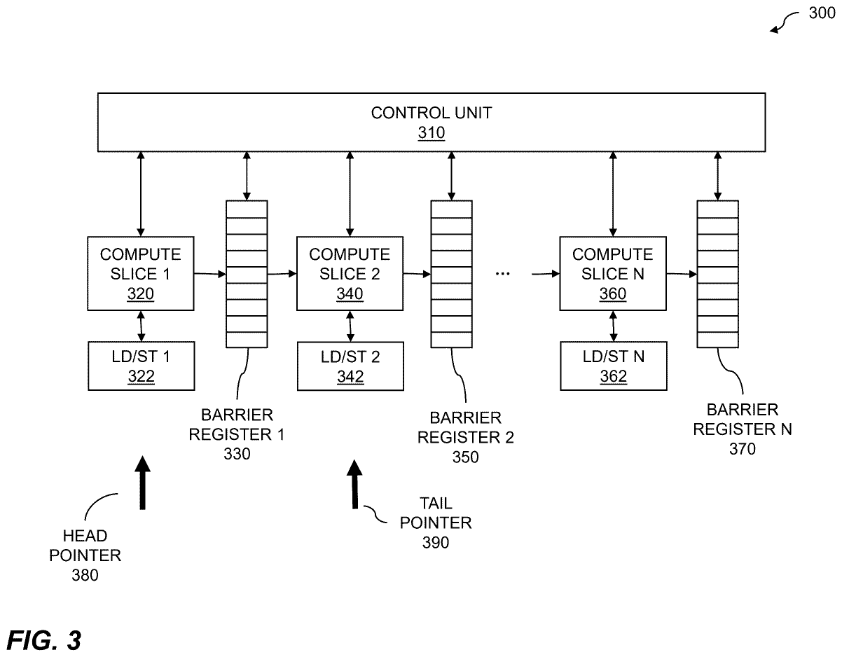

FIG. 3 is a block diagram for compute slice control. A processor such as a processor unit can be used to process data for applications that can include image processing, audio and speech processing, artificial intelligence and machine learning, and so on. The processor unit includes a variety of elements, where the elements include compute slices, barrier register sets, a control unit, busing and networking, and so on. The processor unit can also include a memory system, can access external memory, and the like. The compute slices can obtain data for processing. The data can be obtained from a memory system, cache memory, scratchpad memory, and the like. Compute slices can be coupled together using one or more barrier register files. Thus, a barrier register file exists between compute slices. In a usage example a first compute slice can only write to a first barrier register file and a second compute slice can only read from the first barrier register. The control unit can control data access, data processing, branch prediction, data flow-through, etc. performed by the compute slices. Compute slice control enables generating iteration transfer information for code execution with a compute slice microarchitecture.

A processor core is accessed, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register file. Code associated with the ISA is evaluated, wherein the code includes a first loop, wherein the evaluating includes generating iteration transfer information associated with the first loop. Each slice task within a plurality of slice tasks associated with the first loop is distributed to a compute slice within the plurality of compute slices. The processor core executes the plurality of slice tasks, wherein data forwarding between successive compute slices within the plurality of compute slices is based on the plurality of barrier register files and the iteration transfer information.

Compiled programs that are based on slice tasks can be executed on a parallel processing architecture such as the processor core described herein. Some slice tasks associated with the program, for example, can be executed in parallel, while others must be properly sequenced. The sequential execution and the parallel execution of the tasks are dictated in part by the existence of or absence of data dependencies between tasks. In a usage example, compute slice A, running slice task A, processes input data and produces output data that is required by compute slice B, running slice task B. Thus, for correct results, slice task A must first generate the input required by slice task B before slice task B can execute on compute slice B. In this case, compute slice B can stall while waiting for results from the predecessor slice. Once the results are obtained, compute slice B can execute slice task B speculatively while slice task A proceeds. Compute slice C, however, holds slice task C that executes instructions that process the same input data as slice task A and produces its own output data. Thus, slice task C can be speculatively executed in parallel with slice tasks A and B. The execution of tasks can be based on memory access operations, where the memory access operations include data loads from memory, data stores to memory, and so on. The execution of tasks can further be based on data loads to a barrier register file and data stores to a barrier register file. If, in the example just recited, slice task B were to attempt to access and process data prior to slice task A producing the data required by slice task B, a hazard would occur. Thus, hazard detection and mitigation can be critical to successful parallel processing. The hazards can include write-after-read, read-after-write, and write-after-write conflicts. The hazard detection can be based on identifying memory access operations that access the same address. The hazard detection can include checking between store buffers and load address buffers within a load-store unit coupled to each compute slice.

Data can be moved between a memory such as a memory system, a memory data cache, etc. and storage elements associated with the processing unit. The storage elements associated with the processing unit can include scratchpad memory, register files, and so on. The storage elements associated with the processing unit can include barrier register files. Memory access operations can include loads from memory, stores to memory, memory-to-memory transfers, etc. The storage elements can include local storage coupled to one or more compute slices, storage associated with the processing unit, cache storage, a memory system, and so on.

A block diagram 300 for compute slice control is shown. Compute slice control can include hazard detection and mitigation. The hazard mitigation can be based on distributing and allotting slice tasks to compute slices. One or more hazards, which can be encountered during memory access operations, can result when two or more memory access operations attempt to access the same memory address. While multiple loads (reads) from an address may not create a hazard, combinations of loads and stores to the same address can be problematic. Hazard detection and mitigation techniques enable memory access operations to be performed while avoiding hazards. The memory access operations, which can be performed using load-store units associated with each compute slice, can include loading data from memory and storing data to memory. The data is loaded from memory to supply data slice tasks executing on compute slices. The data can be required or generated by slice tasks associated with programs to be executed on a processing unit. Data produced by the slice tasks can be stored back to memory.

The processing unit can include a control unit 310. The control unit can be used to control one or more compute slices, barrier registers, and so on associated with the processing unit. The control unit can operate based on receiving a set of slice tasks from a compiler. The compiler can include a high-level computer, a hardware language compiler, a compiler developed for use with the processing unit, and so on. The control unit can distribute and allocate slice tasks to compute slices associated with the processing unit. The slice tasks can comprise basic blocks, hyperblocks, separate iterations of a loop, and so on. The control unit can be used to commit a result of a slice task to a barrier register when execution of the slice task has been completed. The control unit can perform checking operations. The checking operations can check that a slice task is a next sequential slice task in a compiled program. The checking can be based on execution of a first compute slice. The control unit can perform assigning operations. The assigning operations can include assigning the next sequential slice task in the compiled program to a second compute slice, assigning a third slice task to a third compute slice, and so on. The control unit can perform state assignment operations. The control unit can assign a state to each compute slice in the plurality of compute slices, where the state is one of idle, executing, holding, or done. The assigned states can be used to determine whether a compute slice is ready to receive a slice task, data is ready to be committed, etc. The state of a compute slice can be used for exception handling techniques. The exception handling techniques can be associated with nonrecoverable exceptions and recoverable exceptions.

The processing unit can include a plurality of compute units. The compute units can be issued, by the control unit, to slice tasks for execution. The slice tasks can include blocks of code associated with a compiled program generated by the compiler. In the figure, the compute slices include compute slice 1 320, compute slice 2 340, and compute slice N 360. The number of compute slices that can be included in the processing unit can be based on a processing architecture, a number of processor cores on an integrated circuit or chip, and the like. A load-store unit can be associated with each compute slice. The load-store unit can be used to provide load data obtained from a memory system for processing on the associated code slice. The load-store unit can be used to hold store data generated by the compute slice and designated for storing in the memory system. The load-store unit can include load-store unit 1 322 associated with compute slice 1 320, load-store unit 2 342 associated with compute slice 2 340, and load-store unit N 362 associated with compute slice N 360. As the number of compute slices changes for a particular processing unit architecture, the number of load-store units can change correspondingly.

The processing unit can include a plurality of barrier register files. The barrier register files can be used to hold load data to be processed by a compute slice, to receive store data generated by a compute slice, and so on. For example, a second compute slice can be coupled to a first compute slice by a first barrier register set in the plurality of barrier register sets. In the block diagram, barrier register 1 330 can couple compute slice 2 340 to compute slice 1 320, barrier register 2 350 can couple compute slice 3 (not shown) to compute slice 2 340, barrier register N 370 can couple compute slice N+1 (not shown) to compute slice N 360, etc. Slice tasks can be issued by the control unit to compute slices in an order such as from left to right. In this case, the left-hand compute slice or predecessor compute slice only has to write to a barrier register coupled to a right-hand compute slice or successor. That is, a successor compute slice does not have to write to a predecessor compute slice, nor does a predecessor compute slice have to read from a successor compute slice. In some embodiments, the plurality of compute slices and the plurality of barrier register files are coupled in a ring configuration. Thus, barrier register N 370 can be coupled between compute slice N 360 and compute slice 1 320.

Pointers can be used to indicate which compute slice has been allocated the first slice task, which compute slice has been allotted the second slice task, and so on. In some embodiments, the executing includes initializing one or more pointers, wherein a head pointer within the one or more pointers points to a first compute slice, and wherein a tail pointer within the one or more pointers points a last compute slice. The initializing the pointers can include pointing to a first compute slice, pointing to a second compute slice, pointing to the last compute slice to which a slice task has been allotted, and so on. In block diagram 300, a head pointer 380 points to the first compute slice, and a tail pointer 390 points to the second compute slice. The pointers can point to two different compute slices, to the same compute slice, etc. In a usage example, a program comprises one slice task, and the one slice task has been assigned to compute slice 1. The head pointer and the tail pointer point to the same compute slice, compute slice 1, because that is the only compute slice to which a slice task has been assigned.

Data movement, whether loading, storing, transferring, etc., can be accomplished using a variety of techniques. Memory system access operations can be performed outside of processing unit, thereby freeing the compute slices with the processing unit to execute slice tasks. Memory access operations, such as autonomous memory operations, can preload data needed by one or more compute slices. The preloaded data can be placed in buffers associated with compute slices that require the data. A semi-autonomous memory copy technique can be used for transferring data. The semi-autonomous memory copy technique can be accomplished by the processing unit which generates source and target addresses required for the one or more data moves. The processing unit can further generate a data size such as 8, 16, 32, or 64-bit data sizes, and a striding value. The striding value can be used to avoid overloading a column of storage components such as a cache memory.

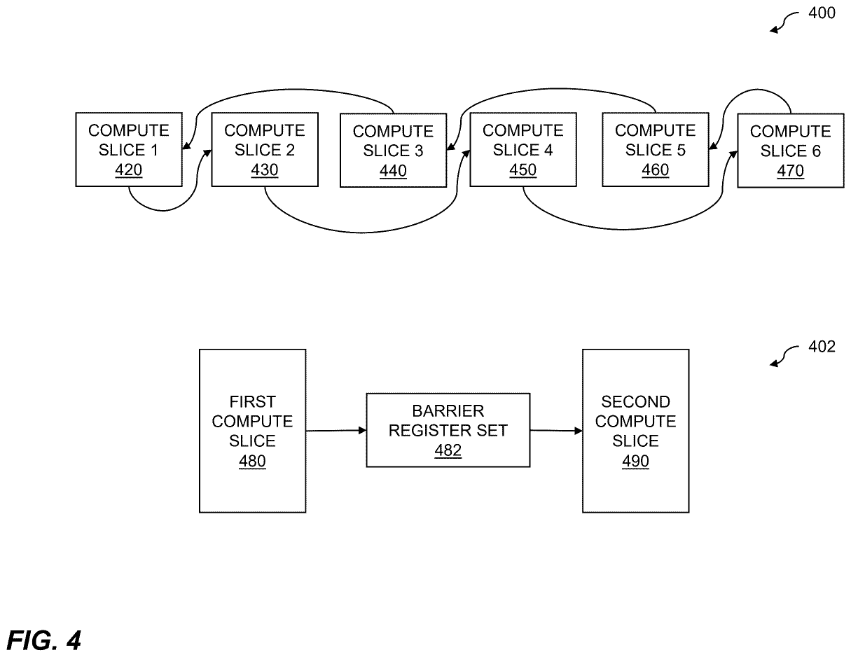

FIG. 4 illustrates a system diagram for a ring configuration of compute slices. Described previously and throughout, a processor core can be used to process a compiled program. The program can be associated with processing applications such as image processing, audio processing, and natural language processing applications. The processing can be associated with artificial intelligence applications such as deep learning. The processor core can include various elements. Among other elements, the processor core can comprise compute slices that are coupled to barrier register sets. A barrier register file can be coupled between two compute slices to enable unidirectional communication between the two compute slices. The barrier register files can be used to hold data for processing by a compute slice, can receive committed effects such as data and branch decisions from the compute slices, and so on. Pointers such as a head pointer and a tail pointer can be used to direct blocks of code issued for execution by a control unit to the compute slices. The compute slices and the barrier register files can be coupled in a ring configuration. The ring configuration of the compute slices and the barrier register sets enable generating iteration transfer information for code execution with a compute slice microarchitecture.

A processor core is accessed, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files. Code associated with the ISA is evaluated, wherein the code includes a first loop, wherein the evaluating includes generating iteration transfer information associated with the first loop. Each slice task within a plurality of slice tasks associated with the first loop is distributed to a compute slice within the plurality of compute slices. The processor core executes the plurality of slice tasks, wherein data forwarding between successive compute slices within the plurality of compute slices is based on the plurality of barrier register files and the iteration transfer information.

An illustration 400 of ring configuration of compute slices is shown. The compute slices within the ring configuration can include compute slice 1 420, compute slice 2 430, compute slice 3 440, compute slice 4 450, compute slice 5 460, and compute slice 6 470. While six compute slices are shown, the ring of compute slices can also comprise more or fewer compute slices. The ring configuration can be accomplished using an integrated circuit or chip, a plurality of compute slice cores, a configurable chip, and the like. The ring configuration 402 can be based on a regularized circuit layout, equalized interconnect lengths, and so on. A compute slice 480 can be coupled to a second compute slice 490 using a barrier register file 482. The barrier register file can include a register file within a plurality of barrier register files. Each compute slice of 400 and 402 can be coupled to a load-store unit (not shown). The load-store unit can handle data and instruction transfers between the compute slices and a memory system. Further, each compute slice can be coupled to a control unit (not shown). The control unit can enable loading and execution of slice tasks, loading and storing data in barrier registers, etc.

Discussed previously, each compute slice can independently execute a block of code called a slice task. The slice tasks that can be associated with the compute slices can be associated with a compiled program. The execution of the slice tasks can be controlled by a local program counter associated with each compute slice. Communication between a slice and its immediate neighbors, such as a predecessor compute slice and a successor compute slice, is accomplished using a barrier register file. Recall that a control unit that can control the compute slices can ensure that the slice task order is issued in one direction such as from left to right. As a result, a compute slice is not required to write to a predecessor compute slice, nor to read from a successor compute slice. In a usage example, the first compute slice can only write to the barrier register and the second compute slice can only read from the barrier register. This architectural technique can ensure that a compute slice that requires input data from a predecessor compute slice can read valid data. That is, the first compute slice generates data, branch decisions, etc., and writes this information to the input of the barrier register while the output of the register remains unchanged. The data being read at the output of the barrier register will remain valid while the second compute slice is processing data. The results from the first compute slice are not committed until after the first compute slice has completed execution and the second compute slice has obtained its data. The committing is performed by the control unit. This technique eliminates a race condition such as a write-before-read race condition.

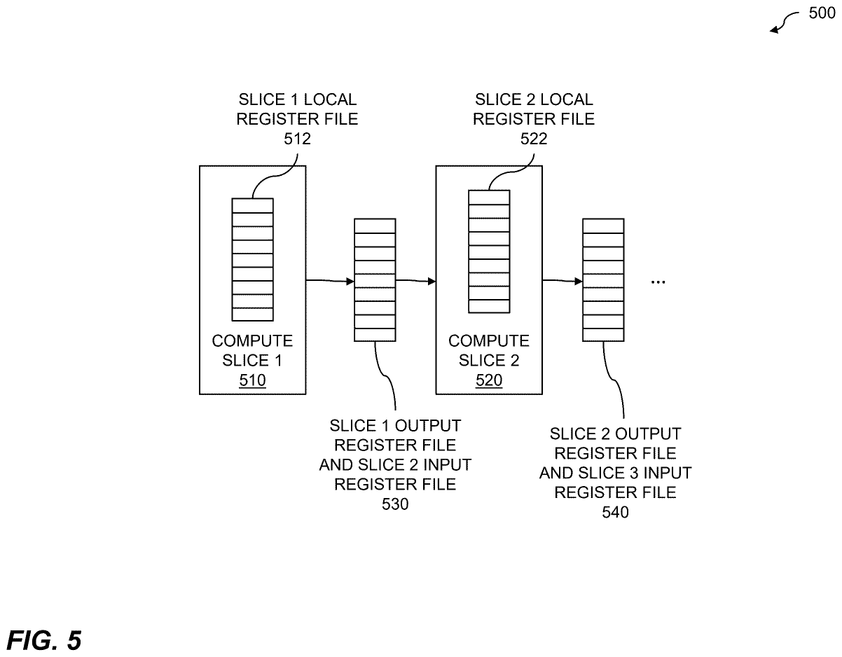

FIG. 5 is an example of barrier registers. Discussed previously, a processor core comprises compute slices and a control unit. Further, the processor core includes barrier registers. A barrier register can be coupled between a compute slice and a predecessor compute slice, between the compute slice and a successor compute slice, and so on. The barrier register set provides for communication of data between successive compute slices. The communication provided by the barrier register is unidirectional. Information can flow from a predecessor compute slice to a barrier register, and from the barrier register to a compute slice. Further, information can flow from the compute slice to a successor compute slice. Communication between and among compute slices can be accomplished using a bus such as an industry standard bus, a ring bus, a network such as a wired or wireless computer network, etc. The communication can be accomplished using a network on chip (NOC) associated with a processor core. The ring bus can be realized using a variety of techniques. The ring bus can be implemented as a distributed multiplexor (MUX). Barrier registers associated with a processor core enable generating iteration transfer information for code execution with a compute slice microarchitecture.

The example 500 shows example compute slices and barrier registers. The compute slices and the barrier registers are within a processor core. The compute slices can include compute slice 1 510 and compute slice 2 520. While two compute slices are shown, other numbers of compute slices can be present with a processor. The barrier registers can include barrier register file 530 and barrier register file 540. Recall that a barrier register can be coupled between two compute slices. The compute slices can include a predecessor compute slice and a compute slice, and a barrier register between the compute slice and a successor compute slice. The compute slices can each include a local register file. The local register file can be used to store intermediate results, inputs from a previous compute slice, etc. In the figure, compute slice 1 includes a local register file 512, and compute slice 2 includes a local register file 522. Data from a predecessor compute slice can be loaded into the local register file of a compute slice if the compute slice processes data from the predecessor compute slice. Alternatively, the data can be obtained directly from the barrier register file. Similarly, data from a processor compute slice can be forwarded through the compute slice to a barrier register that is coupled to the output of the compute slice. Recall that the writing of data to the internal register file of a compute slice and/or to an output register file (e.g., a barrier register) coupled to the compute slice can be based on generated iteration transfer information associated with a loop. The generating includes creating masks. In some embodiments, the generating includes creating, for the first slice task, a first instruction write mask (IWM), wherein the first IWM identifies one or more instructions, within the first slice task, that produce a final write to an architectural register. An instruction that produces a final write to an architectural register can process input data to generate the final write. Further, a successor compute slice can also process data from the same predecessor compute slice. Thus, data obtained via a barrier register coupled between the compute slice and the predecessor compute slice can be written to both the internal register file and the output register file.

In a usage example, an instruction within a slice task distributed to compute slice 1 can generate a final write. Based on the IWM, data accessed by the instruction is written to the slice 1 local register file 512 and to the slice 1 output register file (which is the barrier register file 530). The slice 1 register file also serves as the slice 2 input register file. Thus, compute slice 2 can begin processing data required by the slice task assigned to it. Similarly, an instruction within the slice task distributed to compute slice 2 can generate a final write. Based on an IWM created to the second slice task, data obtained via the register file within the barrier register coupled between the compute slice 1 and compute slice 2 can be written to both the slice 2 local register file 522 and the slice 2 output register file (which is the barrier register file 540). Since this latter file also serves as a slice 3 input register file, slice 3 can process data written to the slice 3 input register file.

In some embodiments, the generating includes forming, for the first slice task, a first register write mask (RWM), wherein the first RWM identifies one or more registers, within the first slice task, that are modified by the first slice task. The RWM can indicate registers that are manipulated by a slice task executed on a compute slice. Registers that are not manipulated by the slice task can be forwarded from an input register file, through the compute slice, to an output register file. In a usage example, some registers associated with the slice 2 input register file (which is barrier register 530) are not included in the RWM. Thus, contents of the registers not within the RWM can be forwarded by compute slice 2 to the slice 2 output register file 540.

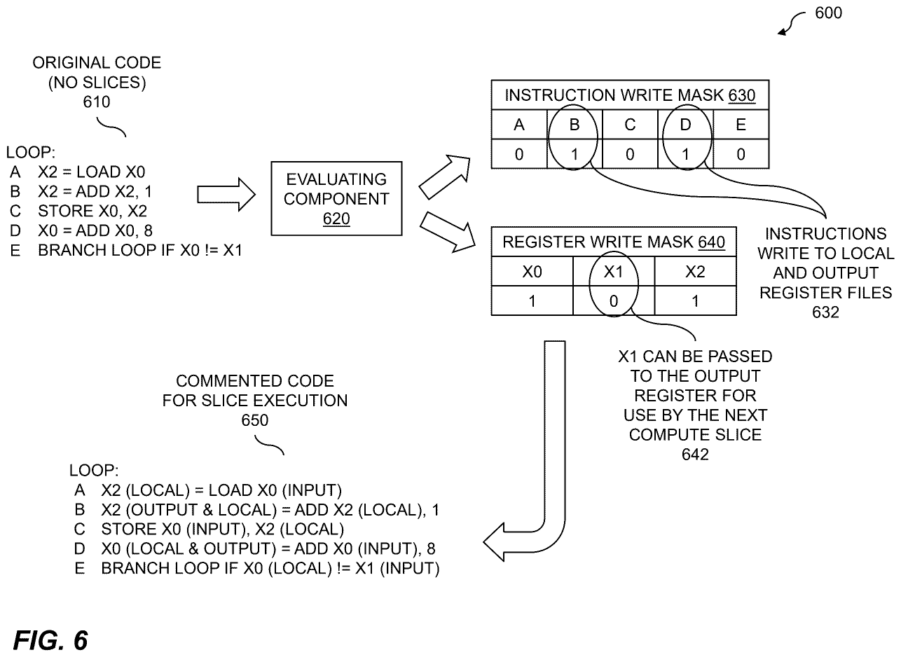

FIG. 6 is an example of slice task execution with write masks. Slice tasks that include a variety of instructions are distributed to compute slices within a processor core. The slice tasks can be associated with iterations of a loop in program code. The slice tasks access data stored in register files. The register files are associated with barrier registers, where barrier registers are coupled between compute slices. The barrier registers provide unidirectional data flow between a predecessor compute slice and a compute slice, a compute slice and a successor compute slice, and so on. Based on the instructions within a slice task, a given compute slice can manipulate contents of some registers within an input register file and can execute a final write to some registers within an output register file. Some registers within the input register file may be accessed for load (read) only, while other registers within the input register file are not accessed. Depending on how registers within the input register file are handled by the slice task, the contents of the input register file can be written to a register file within a compute slice (e.g., a local register file, an internal register file, etc.), written or forwarded to an output register file coupled to the compute slice, or written to both the internal register file and the output register file. The determination of the writing to the internal register file and/or the output register file is based on masks formed from generating iteration transfer information associated with the code loop. The iteration transfer information can be stored within metadata with a binary associated with the code. The compute slice can detect the metadata while executing a slice task and can perform the writing of data to the internal register file, the output register file, or both. The writing speeds execution of slice tasks by forwarding valid or unchanged data to successor or “downstream” compute slices before an upstream slice task completes. Task execution with write masks enables generating iteration transfer information for code execution with a compute slice microarchitecture.

The example 600 includes an original code 610. The original code does not include task slices due to its low number of instructions. The code accesses registers X0, X1, and X2 within a register file. Other registers, such as registers X3, X4, and so on are not accessed by the original code. The original code uses a loop to add one to each value in a series of numbers. The loop ends when the value in X0 is the same as the value in X1. The original code can be associated with an instruction set architecture (ISA). In some embodiments, the ISA comprises a RISC-V™ ISA. The original code is evaluated by an evaluating component 620. Embodiments include evaluating code associated with the ISA, wherein the code includes a first loop, wherein the evaluating includes generating iteration transfer information associated with the first loop. The iteration transfer information can be used to determine which registers are manipulated by each iteration of the loop, which registers remain unchanged, and so on. In some embodiments, the evaluating includes exploring the code, by the processor core, in an information gathering mode, wherein the generating the iteration transfer information is based on the exploring. The exploring the code can occur at various times. In one or more embodiments, the exploring occurs at runtime. The evaluating can be accomplished using a variety of techniques. In other embodiments, the evaluating includes simulating the code, by a compiler, wherein the generating the iteration transfer information is based on the simulating. The compiler can be used to not only compile code, but also to make predictions such as branch predictions. This can be performed for branches in loops, such as the branch found in the code 610. The simulating can occur at various times. In some embodiments, the simulating occurs at compile time. The iteration transfer information can be stored within the compiled code. Embodiments include storing the iteration transfer information within metadata within a binary associated with the code.

In embodiments, the generating includes creating, for the first slice task, a first instruction write mask (IWM) 630, wherein the first IWM identifies one or more instructions, within the first slice task, that produce a final write to an architectural register. A final write can include writing the contents of a register within an internal register file of a compute slice to an output register file. The output register file can be associated with a barrier register coupled between a compute slice and a successor compute slice. The final write can provide data that can be required by the successor compute slice or another downstream compute slice. In the instruction write mask, instructions B and D associated with the loop of the original code are marked with ones. Instructions marked with ones include instructions that write to local or internal register files and also to output register files 632. In some embodiments, the generating includes forming, for the first slice task, a first register write mask (RWM) 640, wherein the first RWM identifies one or more registers, within the first slice task, that are modified by the first slice task. The modified registers are written to the output register file when the contents of the modified registers are valid or when the slice task competes execution. In the RWM shown, register X1 remains unmodified by the loop. Thus, register X1 can be passed or forwarded 642 to the output register for use by the next or successor compute slice.

Example commented code for slice execution is shown 650. Recall that the iteration transfer information can be used to direct a compute slice to write contents of an input register file to a local register file with a compute slice, to an output register file associated with the compute slice, or to both the internal register file and the external register file. The commented code includes terms such as “local” to indicate a local or internal register, “input” to indicate an input register (e.g., from a predecessor barrier register file), “output” to indicate an output register (e.g., to a successive barrier register file), and so on. When more than one metadata term is included such as, “output & local,” then both an output register and a local register are written. A control unit can perform branch prediction and send an iteration of the code loop (e.g., slice tasks) to one or more compute slices. Each iteration executes in parallel with variable reads and writes dictated by the IWM and RWM associated with each slice task. In this way, forwarding can be accomplished between compute slices, allowing for additional parallelism as data stalls are reduced in the processor core.

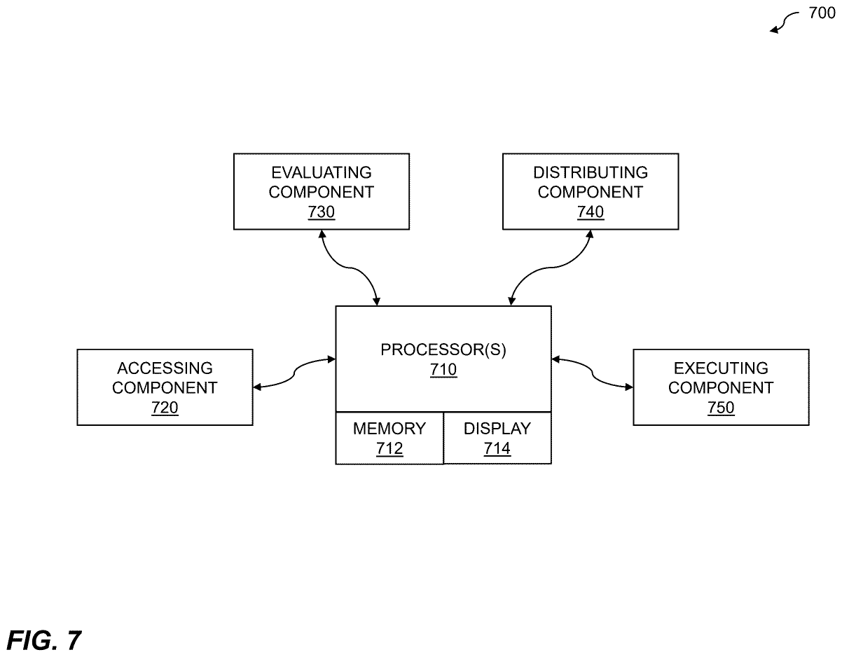

FIG. 7 is a system diagram for generating iteration transfer information for code execution with a compute slice microarchitecture. The task processing is enabled by generating iteration transfer information for code execution with a compute slice microarchitecture. The system 700 can include one or more processors 710 coupled to a memory 712 which stores instructions. The system 700 can further include a display 714 coupled to the one or more processors 710 for displaying data; intermediate steps; task slices; iteration transfer information, code, code iterations, and so on. In embodiments, one or more processors 710 are coupled to the memory 712, wherein the one or more processors, when executing the instructions which are stored, are configured to: access a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files; evaluate code associated with the ISA, wherein the code includes a first loop, wherein evaluating includes generating iteration transfer information associated with the first loop; distribute each slice task within a plurality of slice tasks associated with the first loop to a compute slice within the plurality of compute slices; and execute, by the processor core, the plurality of slice tasks, wherein data forwarding between successive compute slices within the plurality of compute slices is based on the plurality of barrier register files and the iteration transfer information.

The system 700 can include a computer program product embodied in a non-transitory computer readable medium for task processing, the computer program product comprising code which causes one or more processors to perform operations of: accessing a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files; evaluating code associated with the ISA, wherein the code includes a first loop, wherein the evaluating includes generating iteration transfer information associated with the first loop; distributing each slice task within a plurality of slice tasks associated with the first loop to a compute slice within the plurality of compute slices; and executing, by the processor core, the plurality of slice tasks, wherein data forwarding between successive compute slices within the plurality of compute slices is based on the plurality of barrier register files and the iteration transfer information.

The system 700 can include an accessing component 720. The accessing component 720 can include functions and instructions for accessing a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files. The processor core can be accessible within an integrated circuit, an application-specific integrated circuit (ASIC), a programmable unit such as a field-programmable gate array (FPGA), and so on. The processor core can comprise a plurality of compute slices, a plurality of barrier register sets, and a control unit. The processor core can have access to a memory system. Each processing unit is known to a compiler. Each compute slice within the plurality of compute slices includes at least one execution unit. A compute slice can include one or more processors, processor cores, processor macros, processor cells, and so on. Each compute slice can include an amount of local storage such as register files, cache storage, and so on. Local storage may be accessible by one or more compute slices. The compute slices can be organized in a ring. Compute slices within the ring can be accessed using pointers. The pointers can include a head pointer, a tail pointer, and the like. Each compute slice is coupled to a successor compute slice and a predecessor compute slice by a barrier register set in the plurality of barrier register sets. The barrier register set provides for communication of data between successive compute slices. Communication between and among compute slices can be accomplished using a bus such as an industry standard bus, a ring bus, a network such as a wired or wireless computer network, etc. The ring bus can be implemented as a distributed multiplexor (MUX).

The system 700 can include an evaluating component 730. The evaluating component 730 can include functions and instructions for evaluating code associated with the ISA, wherein the code includes a first loop, wherein the evaluating includes generating iteration transfer information associated with the first loop. The iteration transfer information can identify which information within the input information to a slice transfers through the slice unchanged and which information within the input information is processed by the slice task running on the slice. In some embodiments, the generating includes creating, for the first slice task, a first instruction write mask (IWM), wherein the first IWM identifies one or more instructions, within the first slice task, that produce a final write to an architectural register. The one or more instructions identified with the IWM include instructions that write to local register files associated with the slice and to output register files. In further embodiments, the generating includes forming, for the first slice task, a first register write mask (RWM), wherein the first RWM identifies one or more registers, within the first slice task, that are modified by the first slice task. One or more registers not identified with the RWM can be forwarded or “written through” to an output register. The one or more registers that are passed through can provide the data they contain through to the next compute slice. The next compute slice can process the passed-through data while the first compute slice is executing its slice task.

The evaluating can be accomplished using a variety of techniques. In some embodiments, the evaluating includes exploring the code, by the processor core, in an information gathering mode, wherein the generating the iteration transfer information is based on the exploring. The evaluating can include determining data dependencies between compute tasks. The evaluating can be performed at various times. In some embodiments, the exploring occurs at runtime. While the exploring might also occur at compile time, conditional instructions such as those that are based on data can only be predicted prior to runtime. The information transfer information that is generated can be stored in various locations. In some embodiments, the generating includes storing the iteration transfer information within the control unit. The evaluating can be accomplished using other techniques in addition to exploring. In some embodiments, the evaluating includes simulating the code, by a compiler, wherein the generating the iteration transfer information is based on the simulating. The compiler can include a C, C++, or another language compiler. The compiler can include a compiler written especially for the processor core. In one or more embodiments, the simulating occurs at compile time. The iteration transfer information that is generated by the simulating can be stored in various locations. Other embodiments include storing the iteration transfer information within metadata within a binary associated with the code.

The system 700 can include a distributing component 740. The distributing component 740 can include functions and instructions for distributing each slice task within a plurality of slice tasks associated with the first loop to a compute slice within the plurality of compute slices. Recall that code to be executed by the processor includes a first loop. The loop can be partitioned into tasks (e.g., slice tasks) by a control unit associated with the processor core. The control unit can distribute each compute task to compute slices within the processor core. The distribution of slice tasks can be based on various task distribution techniques such as round robin, weighted round robin, least task first, max-availability, and so on. The distribution can be based on a “pull” technique, where slice tasks are pulled from a task priority queue. The distribution can be based on dependencies between slice tasks. In a usage example, a portion of the distributed slice tasks can execute in parallel, other slice tasks can execute sequentially, etc. Any number of slice tasks can be sent to the compute slices by the control unit. The distributing can be based on one or more instruction write masks (IWMs), one or more register write masks (RWMs), etc. As described above, the RWM can indicate one or more architectural registers that are modified within each slice task, loop iteration, basic block, hyperblock, and so on. The register write mask can then be used to send data efficiently between compute slices. Local registers not written within a basic block, hyperblock, loop iteration, etc. running on a compute slice can be forwarded to the subsequent slice. Even if the forwarding occurs before a compute slice is finished executing, the forwarding will not result in data loss since it was previously determined, by the iteration transfer information, that the compute slice does not update those registers.

In some embodiments, the distributing is based on a branch prediction logic within the control unit. The branch prediction unit can be used to predict an outcome of a branch instruction such as a conditional branch instruction. The branch prediction can be based on code execution history, simple prediction rules, and so on. The branch prediction can be used to improve processor core throughput when the prediction is accurate by keeping an instruction queue populated with pending instructions. However, modern branch prediction techniques are not usually 100 percent accurate. In some embodiments, a branch instruction in the first compute slice was mispredicted. A misprediction indicates that any instructions executed and data processed based on the mispredicted branch are unneeded. The branch misprediction can impact processing performed by a “downstream” or successor compute slice. Some embodiments include ignoring a result from the second compute slice, by the branch prediction logic. Further, the second compute slice needs to wait until required results from the first compute slice are available. Some embodiments include stalling, by the second compute slice, until one or more results from the first slice task, which are required inputs for the second slice task, are written to the first barrier register file.

The system 700 can include an executing component 750. The executing component 750 can include functions and instructions for executing, by the processor core, the plurality of slice tasks, wherein data forwarding between successive compute slices within the plurality of compute slices is based on the plurality of barrier register files and the iteration transfer information. The program can include a plurality of slice tasks, where the slice tasks can be determined by the compiler, by the control unit, by metadata, by a combination of these, etc. The slice tasks can comprise basic blocks, hyperblocks, etc. The slice tasks that are executed may include a branch operation. If the task does include a branch operation, a branch outcome can be predicted. In a usage example, the first slice task can be executed, by the first compute slice, without a prediction of the conditional operation. The executing can begin at the first compute slice. While one slice task can be executed, other slice tasks can be executed in parallel. The executing a code slice can generate data for a successor slice task. Execution of slice tasks that depend on an outcome of a first slice task branch decision can continue execution when the branch prediction and the branch outcome are substantially similar. Other actions can be taken if the branch prediction and the branch outcome are substantially different. A result from a successor compute slice can be ignored when a branch instruction in the first compute slice was mispredicted by the branch prediction logic in the control unit. In this case, the slice task running on the second compute slice, which was based on the incorrectly predicted branch path of the first slice, becomes irrelevant. The results can be ignored, flushed, etc. Further actions can be taken based on the branch misprediction. For example, the tail pointer can be updated to point to the first compute slice, which is the last known code that properly followed the execution path as determined by the executed branch instruction.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files;
evaluating code associated with the ISA, wherein the code includes a first loop, wherein the evaluating includes generating iteration transfer information associated with the first loop;
distributing each slice task within a plurality of slice tasks associated with the first loop to a compute slice within the plurality of compute slices; and
executing, by the processor core, the plurality of slice tasks, wherein data forwarding between successive compute slices within the plurality of compute slices is based on the plurality of barrier register files and the iteration transfer information.

2. The method of claim 1 wherein the plurality of compute slices includes a first compute slice executing a first slice task within the plurality of slice tasks that were distributed.

3. The method of claim 2 wherein the plurality of compute slices includes a second compute slice executing a second slice task within the plurality of slice tasks that were distributed, wherein the first compute slice is coupled to the second compute slice by a first barrier register file within the plurality of barrier register files.

4. The method of claim 3 wherein the first barrier register file comprises an output register file associated with the first compute slice.

5. The method of claim 3 wherein the first barrier register file comprises an input register file for the second compute slice.

6. The method of claim 3 wherein the generating includes creating, for the first slice task, a first instruction write mask (IWM), wherein the first IWM identifies one or more instructions, within the first slice task, that produce a final write to an architectural register.

7. The method of claim 6 wherein the executing includes writing, by the first compute slice, data associated with the one or more instructions that were identified by the first IWM, to both the local register file within the first compute slice and the first barrier register file.

8. The method of claim 3 wherein the generating includes forming, for the first slice task, a first register write mask (RWM), wherein the first RWM identifies one or more registers, within the first slice task, that are modified by the first slice task.

9. The method of claim 8 wherein the executing includes forwarding, by the first compute slice, data associated with one or more registers that were not identified by the first RWM, from a predecessor barrier register file to the first barrier register file.

10. The method of claim 3 wherein the distributing is based on branch prediction logic within the control unit.

11. The method of claim 10 wherein a branch instruction in the first compute slice was mispredicted.

12. The method of claim 11 further comprising ignoring a result from the second compute slice, by the branch prediction logic.

13. The method of claim 3 further comprising stalling, by the second compute slice, until one or more results from the first slice task, which are required inputs for the second slice task, are written to the first barrier register file.

14. The method of claim 1 wherein the evaluating includes exploring the code, by the processor core, in an information gathering mode, wherein the generating the iteration transfer information is based on the exploring.

15. The method of claim 14 wherein the exploring occurs at runtime.

16. The method of claim 14 wherein the generating includes storing the iteration transfer information within the control unit.

17. The method of claim 1 wherein the evaluating includes simulating the code, by a compiler, wherein the generating the iteration transfer information is based on the simulating.

18. The method of claim 17 wherein the simulating occurs at compile time.

19. The method of claim 17 further comprising storing the iteration transfer information within metadata within a binary associated with the code.

20. The method of claim 1 wherein the executing includes initializing one or more pointers, wherein a head pointer within the one or more pointers points to a first compute slice, and wherein a tail pointer within the one or more pointers points a last compute slice.

21. The method of claim 1 wherein the plurality of compute slices and the plurality of barrier register files are coupled in a ring configuration.

22. The method of claim 1 wherein each slice task within the plurality of slice tasks comprises one or more instructions that were distributed to a compute slice within the plurality of compute slices.

23. The method of claim 1 wherein the ISA comprises a RISC-V™ ISA.

24. A computer program product embodied in a non-transitory computer readable medium for task processing, the computer program product comprising code which causes one or more processors to perform operations of:
accessing a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files;
evaluating code associated with the ISA, wherein the code includes a first loop, wherein the evaluating includes generating iteration transfer information associated with the first loop;
distributing each slice task within a plurality of slice tasks associated with the first loop to a compute slice within the plurality of compute slices; and
executing, by the processor core, the plurality of slice tasks, wherein data forwarding between successive compute slices within the plurality of compute slices is based on the plurality of barrier register files and the iteration transfer information.

25. A computer system for task processing comprising:
a memory which stores instructions;
one or more processors coupled to the memory, wherein the one or more processors, when executing the instructions which are stored, are configured to:
access a processor core, wherein the processor core is configured to execute instructions associated with an instruction set architecture (ISA), wherein the processor core comprises a plurality of compute slices, a plurality of barrier register files, and a control unit, wherein each compute slice within the plurality of compute slices includes at least one arithmetic logic unit (ALU), a local register file, and is coupled to a successor compute slice and a predecessor compute slice by a barrier register file in the plurality of barrier register files;
evaluate code associated with the ISA, wherein the code includes a first loop, wherein evaluating includes generating iteration transfer information associated with the first loop;
distribute each slice task within a plurality of slice tasks associated with the first loop to a compute slice within the plurality of compute slices; and
execute, by the processor core, the plurality of slice tasks, wherein data forwarding between successive compute slices within the plurality of compute slices is based on the plurality of barrier register files and the iteration transfer information.
